(19) United States
(12) Patent Application Publication
(10) Pub. No.: US 2011/0290074 A1
(43) Pub. Date: Dec. 1, 2011

(54) Power Split Transmission and Method for Controlling the Same

(75) Inventors: Horst Schulte, Berlin (DE); Jürgen Winkelbake, Neu-Ulm (DE); Thomas Anderl, Neu-Ulm (DE)

(73) Assignee: Robert Bosch GmbH, Stuttgart (DE)

(21) Appl. No.: 13/130,887

(22) PCT Filed: Oct. 26, 2009
(86) PCT No.: PCT/EP2009/007644

§ 371 Date: Aug. 12, 2011

(30) Foreign Application Priority Data
Nov. 26, 2008 (DE) 10 2008 059 029.0

(51) Int. Cl. F16H 61/66; F16H 61/40

(52) U.S. Cl. 74/733.1; 74/405

(57) ABSTRACT

A power split transmission includes a first power branch having a continuously variable transmission and a separable second power branch. The two power branches are combined again in a summation gear and a device connects or disconnects the second branch when a synchronous condition is present when changing from an initial driving range into a target driving range. A control device for controlling and adjusting the transmission ratio of the first power branch is connected to the continuously variable transmission. A predicting device for predicting an efficiency ηᵥ of the first power branch in a target driving range is connected to the control device. The control device is set up such that the continuously variable transmission is adjusted when changing into the target driving range, considering the predicted efficiency ηᵥ, so that a difference in speed at the output of the first power branch due to a change in the flow of power in the first power branch is exactly compensated for by connecting or disconnecting the second power branch.

The invention relates to a power split transmission and to a method to be carried out during a changeover of driving range.

In change speed and automatic transmissions with hydrodynamic converters, which have been established for years, transmission stages are changed either by means of mechanical synchronizing elements or by slip at the converter element. The transmission ratio jumps to be overcome here give rise to changes in rotational speed and torque at the drive and the output. Various transmission stages are also used to permit a good efficiency level over the entire speed range in continuously variable transmission concepts by virtue of the limited spread of the electrical or mechanical or hydrostatic variators. In theory, the changeover between driving ranges could also be carried out without changing the drive speed or output speed and also without an interruption in the tractive force by utilizing the additional degree of freedom in the variator.

For example, German laid-open patent application DE 10 2007 037 107 A1 presents a power split transmission having a first hydrostatic power branch with a hydrostatic variator, and having a second mechanical power branch which can be disconnected by means of a clutch. The two power branches are combined in a summing gear mechanism section. In a first driving range, the second power branch is disconnected and moved only by means of the first power branch. For the purpose of acceleration, the variable transmission ratio of the first power branch is increased by controlling the hydrostatic variator. If the disconnected output of the second power branch, which is driven by the first power branch via the summing gear mechanism, reaches a rotational speed which corresponds to the drive of the second power branch, synchronization is brought about, and the clutch of the second power branch is closed, and the second power branch is also connected to the summing gear mechanism. When this synchronizing rotational speed is reached, there is therefore a changeover into the second, power split driving range.

However, since a real variator also has different power losses in different driving ranges, this ideal of a changeover of driving range which is free of an interruption in the tractive force has not been achieved up to now.

The object of the invention is to provide a power split transmission and a method for changing over between driving ranges which solve the problems of the prior art. Above all, the objective is to implement a simple solution for changing over between driving ranges without a change in the tractive force while at the same time ensuring a high level of transmission capability.

The object is achieved by means of the power split transmission according to the invention as claimed in claim 1. A power split transmission has for this purpose a first power branch with a continuously variable transmission ratio and a disconnectable second power branch. The two power branches are combined in a summing gear mechanism. A device connects or disconnects the second power branch from the summing gear mechanism at the changeover from an initial driving range into a target driving range when a synchronization condition is met. A control device for controlling and setting the transmission ratio of the first power branch is connected to the first power branch. A prediction device for predicting an efficiency level of the first power branch in a target driving range is connected to the control device. The control device is configured in such a way that the continuously variable transmission is set at a changeover into the target driving range, taking into account the predicted efficiency level, in such a way that a difference in rotational speed at the output of the first power branch due to a change in the power flux in the first power branch is just compensated by connecting or disconnecting the second power branch.

The object is additionally achieved by the method according to the invention as claimed in claim 8. The method according to the invention for changing over from an initial driving range into a target driving range controls a power split transmission having a first power branch with a continuously variable transmission and having a second, disconnectable power branch. The efficiency level of the first power branch in the target driving range is predicted, and when a synchronization condition is met the second power branch is connected or disconnected in order to change over from the initial driving range into the target driving range. The continuously variable transmission of the first power branch is then set, taking into account the predicted efficiency level, in such a way that a difference in rotational speed at the output of the first power branch due to a change in the resulting power flux in the first power branch is just compensated after the changeover into the target driving range.

The dependent claims relate to advantageous developments of the power split transmission according to the invention and to the method according to the invention.

The advantage of the invention compared to the prior art is that the efficiency level in the target driving range is predicted before the changeover of driving range, and the variable transmission ratio of the first power branch is correspondingly corrected after the connection or disconnection of the second power branch. The problems of the finite compensation time and the use of complex and very dynamic measuring and control equipment therefore does not at all occur here.

It is particularly advantageous to estimate an instantaneous efficiency level of the first power branch and to predict the efficiency level of the first power branch in the target driving range on the basis of the estimated instantaneous efficiency level. As a result, the reliability of the prediction can be ensured under different operating conditions such as, for example, fluctuating temperatures.

In particular, hydrostatic power transmissions are customary in the field of mobile working machines. For this reason it is particularly advantageous to implement the continuously variable transmission by means of a hydrostatic variator comprising a hydraulic motor and a hydraulic pump. The transmission ratio is set by means of the expulsion volume of the hydraulic motor and/or of the hydraulic pump. The hydraulic motor and the hydraulic pump form a close circuit via two hydraulic lines. In this context, the transmission in a variator can also be implemented mechanically or electrically.

It is particularly advantageous for a power split transmission according to the invention having a hydrostatic variator in the first power branch to estimate an instantaneous volumetric efficiency level of the hydrostatic variator on the basis of the pressure difference between the two lines which connect the hydraulic motor and the hydraulic pump. The efficiency level of the first power branch in the target driving range can then be predicted on the basis of the instantaneous volumetric efficiency level of the variator since the power loss in the rest of the first power branch remains virtually constant in the different driving ranges. As a result, the efficiency level of the first power branch can be predicted on the basis of the pressure difference in the two lines, which is easy to measure.

An exemplary embodiment of the invention is described below on the basis of the drawing, in which:

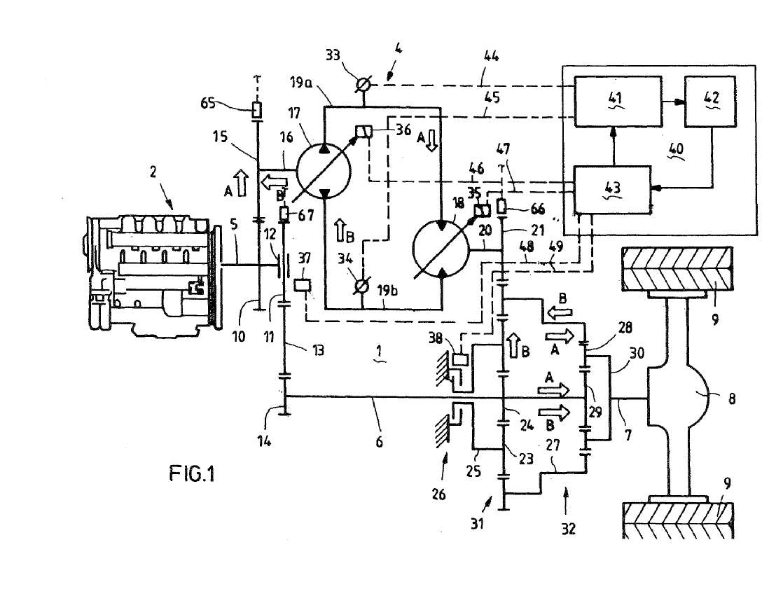

FIG. 1 shows a schematic illustration of an exemplary embodiment of the power split transmission according to the invention;

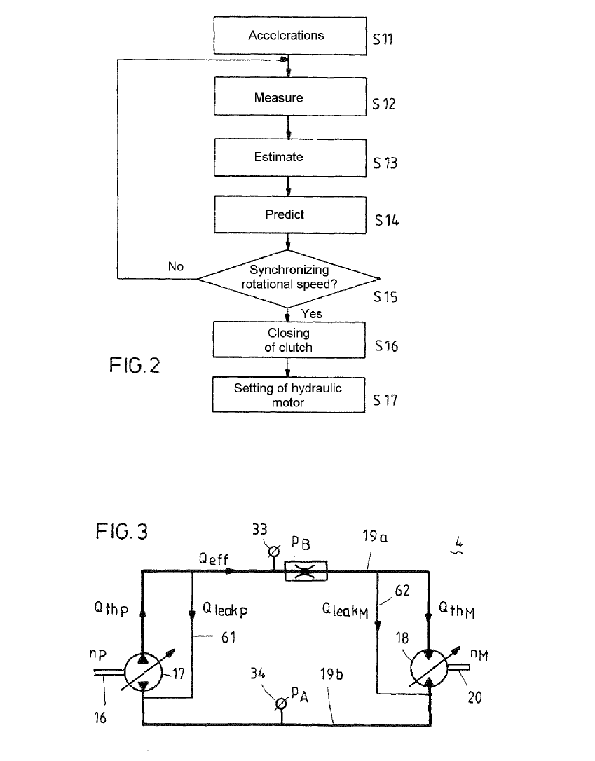

FIG. 2 shows a sequence of an exemplary embodiment of the method according to the invention;

FIG. 3 shows a model for calculating the volumetric efficiency level of a hydrostatic variator; and

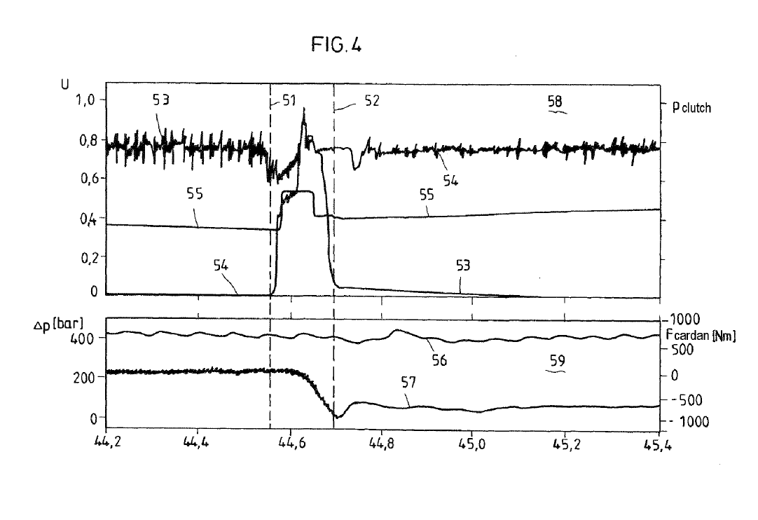

FIG. 4 shows various measurement variables and parameters of the power split transmission according to the invention during the changeover of driving range, plotted against the time.

FIG. 1 shows a power split transmission 1 according to the invention, which transmits the power of an internal combustion engine 2 as the drive engine to at least one driven wheel 9. For this purpose, the internal combustion engine 2 drives a main drive shaft 5 and a gearwheel 10 which is connected to the main drive shaft 5 in a fixed and frictionally locking fashion. In addition, the main drive shaft 5 can be connected via a frictionally locking clutch 12 to a further gearwheel 11 as an input of the second power branch.

The second power branch has a fixed transmission ratio which is determined by the gearwheels 11, 13 and 14, and in the case of a closed clutch 12, i.e. in the case of a connected second power branch, transmits the power of the internal combustion engine 2 at least partially to the output shaft 6 as an output of the second power branch via the specified gearwheels 11, 13 and 14. The rotational speed of the gearwheel 11 is sensed by a rotational speed sensor 67.

The gearwheel 10 of the main drive shaft 5 drives a gearwheel 15 of the first power branch, which gearwheel 10 is mounted in a frictionally locking fashion on a first pump drive shaft 16. The pump drive shaft 16 drives a hydrostatic transmission 4 with a continuously variable transmission. The hydrostatic transmission 4 in turn transmits the supplied power to an engine output shaft 20 and to a gearwheel 21 which is fixably mounted thereon as an output of the first power branch.

The rotational speed of the pump drive shaft 16 is sensed by a rotational speed sensor 65, and the rotational speed of the engine output shaft 20 is sensed by a rotational speed sensor 66. The rotational speed of the main drive shaft 5 also occurs at the pump drive shaft 16.

The hydrostatic transmission 4 has an adjustable hydraulic pump 17 which is driven by the pump drive shaft 16. The driven hydraulic pump 17 pumps hydraulic oil or some other hydraulic fluid via a first hydraulic line 19a to an adjustable hydraulic motor 18 of the hydrostatic transmission 4, which is driven by the hydraulic oil flowing through it. The hydraulic motor 18 in this way drives the engine output shaft 20 and feeds the hydraulic oil back to the hydraulic pump 17 via the second line 19b.

The hydrostatic transmission 4 is controlled by a control device 43 in a control unit 40 for setting the transmission ratio, wherein the control device 43 transmits the electrical actuation signals to proportional magnets 35 and 36 of actuating devices via electrical lines 47 and 46. The actuating devices change, for example in a way which is proportional to the actuation signals of the control device 43, the respective angle of the swash plates or sloping axes of the hydraulic motor 18 and/or of the hydraulic pump 17 and therefore respectively the expulsion volume which is set. The rotational speed of the hydraulic motor 17 can be increased and the transmission ratio from the drive speed to the output speed can be made larger by increasing the pump volume of the hydraulic pump 17 and/or by reducing the expulsion volume of the hydraulic motor 18. It is therefore possible to adjust the transmission ratio in a continuous fashion by varying the pivoting angle of the swash plate of the hydraulic pump 17 and hydraulic motor 18.

The summing gear mechanism of the exemplary embodiment is composed of two coupled planetary gear mechanisms 31 and 32. The planetary gear mechanisms 31 and 32 have rigidly coupled ring gears. The ring gears of the first and second planetary gear mechanisms 31 and 32 are described as functional, since they are in fact a single component 27 which has the two functional ring gears. In this context, the ring gear component of the first planetary gear mechanism 31 has teeth not only on the inside but also on the outside of the ring gear. The outer toothed ring of the common ring gear 27 forms here the first input of the summing gear mechanism into which the gearwheel 21 engages as an output of the first power branch. The two sun gears 24 and 29 of the first and second planetary gear mechanisms 31 and 32 are each seated connected in a frictionally locking fashion on the output shaft 6 of the second power branch, which output shaft 6 at the same time forms the output of the second power branch and the second input of the summing gear mechanism. The two planetary gear mechanisms 31 and 32 accordingly have a fixed coupling between the two sun gears 24 and 29 and between the two functional ring gears which are implemented as one component 27.

The planetary gears 23 of the first planetary gear mechanism 31 are securable at the housing end by means of a planetary carrier 25 and by means of a clutch 26 so that when the clutch 26 is closed the planetary gears 23 can only rotate about their own axis, but cannot perform translation or rotation about the output shaft 6. As a result, a transmission, which is determined structurally by the planetary gear mechanism components, between the functional ring gear of the first planetary gear mechanism 31 and the sun gear 24 and therefore also the sun gear 29 can be determined. The planetary gears 28 of the second planetary gear mechanism 32 rotate about the axis of the output shaft 6 owing to the tooth speeds of the sun gear 29 and those of the functional ring gear of the second planetary gear mechanism 32 being opposed to one another and having different absolute values. This rotational movement of the planet gears 28 is transmitted via a further planet carrier 30 to a main output shaft 7 which, according to the prior art, are conducted for example via a differential 8 and two half shafts to the wheels 9. For this reason, the two planetary gear mechanisms 31 and 32 have to have different transmission, with the result that the ring gear 27 and the sun gear 29 have different speeds in terms of absolute value when the clutch 26 is closed, since in the first planetary gear mechanism 31 the planet gears 23 are locked, and given the same design of the planetary gear mechanism 32, the planet gears 28 would also be stationary. If the clutch 26 is opened, the planet gears 23 can also rotate about the axis of the output shaft 6, and there is no fixed transmission ratio between the sun gear 24 and the ring gear 27.

The two clutches 26 and 12 are each opened or closed by activation devices 38 and 37. The activation devices 38 and 37 are controlled by the control device 43 of the control unit 40 via control lines 49 and 48.

In a first slow driving range, driving is performed purely with the hydrostatic power branch, and the clutch 12 is opened, with the result that the second power branch is interrupted or disconnected and is no longer driven directly by the internal combustion engine 2.

The clutch 26 is closed in the first driving range in order, as described above, to connect the first and second inputs of the summing gear mechanism with a fixed transmission ratio to the output of the first power branch. The rotational speed and torque are therefore transmitted only via the first power branch. For starting, a working machine normally requires a very high torque, for this reason the motor 18 is set to a maximum expulsion volume, and the pump 17 increases the pump volume starting from a negligibly small pump volume. As a result, by reducing the transmission starting from an infinitely large transmission of the hydrostatic transmission 4, it is possible to start and speed up in the first driving range. The internal combustion engine 2 can therefore also be operated with an efficient rotational speed. Once the maximum pump volume has been reached, the expulsion volume of the motor 18 can be reduced further. The power flux in the first driving range is shown in FIG. 1 by the arrows “A”.

Since the output of the first power branch in the first driving range is connected via the summing gear mechanism, or to be more precise via the first planetary gear mechanism 31, to the output of the first power branch in a frictionally locking fashion, the second power branch composed of the output shaft 6 and the gearwheels 14, 13, 11 is also driven. If the vehicle is then accelerated or the expulsion volume of the motor 18 is reduced so far in the case of maximum pump volume that the main drive shaft 5 and the gearwheel 11 have reached the same rotational speed, the clutch 12 can be closed without further adaptation of the rotational speed, and the main drive shaft 5 can also be connected to the second input of the summing gear mechanism via the second power branch. The activation device 37, which is actuated by a control signal from the control 43 which is transmitted via the line 48 from the control 43 closes the clutch 12. After the clutch 12 has been closed and the second power branch has been connected, the clutch 26 is opened, with the result that the second power branch now drives the sun gears 24 and 29, while the first power branch drives the ring gear 27. This is now the second, power split driving range. As a result of braking the ring gear by increasing the motor pivot angle and the expulsion volume of the hydraulic motor 18 and subsequent reduction of the pump volume, the relative speed between the ring gear 27 and sun gear 29 which are running in opposite directions is increased. As a result, the planetary gears 28 and therefore the wheels 9 are accelerated further. For the exemplary embodiment described here it is important that the hydrostatic variator 4 has a negative transmission, i.e. that the drive shaft 16 rotates in the opposite direction to the engine output shaft 20, since otherwise the main drive shaft 5 would rotate in the opposite direction to the gearwheel 11. However, the description of the changing of the transmission always relates to the absolute value of the transmission.

In the previous embodiment, the leakage flows in the hydraulic motor 18 and the hydraulic pump 17, which are generally combined in the volumetric efficiency level of the hydrostatic transmission 4, are ignored. For this reason, in the first driving range the motor pivot angle is always set to a somewhat smaller value than in the ideal loss-free case. Even if the two inputs of the summing gear mechanism are not fixedly connected to one another in the second driving range, power is nevertheless transmitted from the second power branch to the first power branch via the planet gears 23 and 28. This reactive power flux of the second driving range is indicated by the arrows denoted by B. As a result, a reversal of the power flux occurs in the hydrostatic variator 4, and the volumetric efficiency level thereof is turned around. That is to say the hydraulic motor 18 operates as a pump and the hydraulic pump 17 operates as a motor, which components continue to be referred to as a hydraulic motor 18 and hydraulic pump 17 independently of their function. In order to compensate for the losses in rotational speed and owing to the desired continuous transition of the transmission at the boundary between the first and second driving ranges, at the start of the second driving range the pivot angle of the motor 18 is always set with a continuously larger value than in the ideal case.

In the transition region, both clutches 12 and 26 in the power split transmission 1 are closed, since a certain overlap is necessary in order to implement a reliable transfer of torque between the clutch which is to be opened and the clutch which is to be closed. Because of the tolerances and uncertainties during the buildup of pressure at the clutch and when there is a change in load torque it must be ensured that the clutch 12 can transmit the torque of the internal combustion engine 2 in all cases. The clutch switching process is a continuous process in which the clutch 12 which is shifted for this purpose firstly slips along, then comes to bear and briefly prestresses the drive train owing to the kinematic forced coupling before the previously activated clutch 26 is open.

However, the brief prestressing in the transition region prevents the hydraulic motor rotational speed being able to be adjusted by changing the hydraulic motor pivot angle. This rotational speed cannot be varied again until the previously closed clutch 26 is opened. Starting from this time it is then in principle possible to continuously compensate the difference in rotational speed which inevitably occurs, caused by the sudden leakage-flow-dependent changes in efficiency level. However, as a result it is not possible to implement an interruption-free tractive force owing to the finite compensation time. An undesired dip in torque or increase in torque is prevented only by the procedure according to the invention in which the hydraulic motor is set in a controlled fashion in the transition region to the suitable pivot angle, which is adjusted according to efficiency levels. The idea of this invention is to predict the efficiency level at the start of the second driving range and to set the motor pivot angle during the changeover of driving range, i.e. while both clutches 12 and 26 are closed, by taking into account this predicted efficiency level, in such a way that a change in rotational speed does not occur at the output of the hydrostatic variator 4 owing to the reversal of the power flux if the clutch 26 is opened. Prediction is understood here to be a calculation of the efficiency level before or during the closing of the clutch 12, with the result that the pivot angle of the hydraulic motor 18 can be correspondingly set directly after the closing of the clutch 12, and when the clutch 26 opens, the displacement volume which is calculated from the predicted efficiency level is already present.

FIG. 2 describes an exemplary embodiment of the method according to the invention which is described below together with an exemplary embodiment of the power split transmission according to the invention in FIG. 1. FIG. 2 describes by way of example a changeover of driving range from the first slow driving range as the initial driving range into a relatively fast second driving range as the target range.

In step S11, the power split transmission 1 is located in the first driving range, and the vehicle is accelerated by reducing the transmission ratio of the hydrostatic transmission 4. In the following steps S12 to S14, process parameters are continuously measured, the instantaneous volumetric efficiency level is estimated, and on the basis of the instantaneous efficiency level, a prediction of the volumetric efficiency level in the second driving range is made. This will be explained below in more detail with respect to FIG. 3. The intention here is that it will be possible to predict the efficiency level as easily as possible and on the basis of a small number of process parameters which are easy to measure.

FIG. 3 shows a simple model of the leakage flows of the hydrostatic transmission 4. FIG. 3 also shows, in addition to the real lines 19a and 19b, the leakage flows 61 and 62 of the hydraulic pump 17 and the hydraulic motor 18. This results in the volumetric efficiency level

$$η v = \frac{{Q}_{thP} - {Q}_{LeakP}}{{Q}_{thM} + {Q}_{LeakM}} \cdot \frac{{Q}_{thM}}{{Q}_{thP}} \qquad ( 1 )$$

from the theoretical motor flows and pump flows which are corrected for the leakage flows. Q_{thP}, Q_{thM} denote here the theoretical volume flow of the hydraulic pump 17 and/or hydraulic motor and Q_{LeakP}, Q_{LeakM} denote the associated flow losses. The ideal volume flows

Q_{thM}=V_{M}max·uM·nM (2)

Q_{thP}=V_{P}max·uP·nP (3)

can be calculated from the hydraulic motor rotational speed or the hydraulic pump rotational speed n and the respective standardized actuation signal u of the control device 43. Vp, Vm denote the maximum expulsion volume of the hydraulic pump 17 and of the hydraulic motor 18, respectively. Assuming that the leakage flows of the hydraulic motor 18 and hydraulic pump 17 are of equal magnitude, all that is necessary is to estimate an overall leakage flow in order to calculate the instantaneous volumetric efficiency. The overall leakage flow

Q_{Leak}=θ_{Δp}·Δp=Q_{thP}−Q_{thM} with Δp=p_{B}−p_{A} (4)

is determined in a first approximation from a linear relationship with the pressure difference ΔP between the two lines 19a and 19b. The estimation parameter θ_{Δp} is estimated here once offline on the basis of the measured pressures in the two lines 19a and 19b, the rotational speeds nₚ, n_{M} and the standardized actuation signals uₚ, u_{M} on the basis of the preceding relationships (2), (3) and (4) using the least square method. The estimated parameter θ_{Δp} is then stored as a fixed value in an estimation device 41 in the control unit 40. This estimation device 41 is connected to the pressure sensors 33 and 34 via the lines 44 and 45, measures the pressure difference and can therefore calculate the overall leakage flow with the stored estimated parameter. In addition, the estimation device 41 is connected to the control device 43 in order to obtain the respective instantaneous actuation signals and be provided with the rotational speeds of the hydraulic pump 17 and hydraulic motor 18, which are detected and transmitted by the sensors 65 and 66. The instantaneous volumetric efficiency level can be estimated in this way using the equations (1), (2) and (3). In this context, the motor flow Q_{LeakM} and pump leakage flow Q_{LeakP} are respectively assumed to be half the overall leakage flow. Since the instantaneous volumetric efficiency level can be calculated at any time from the equations (1), (2), (3) and (4) and from the pressure difference, the actuation signals, the rotational speeds and the estimated parameter θ_{Δp}, the instantaneous efficiency level can also be referred to as being “calculated”. However, since the parameter θ_{Δp} is estimated, the instantaneous volumetric efficiency level is also referred to as being “estimated”.

Linear and non-linear models of a higher order are also conceivable for improving the estimation. For example, a linear model was examined which describes the overall leakage flow as a linear combination of the rotational speed and the actuation signal of the respective hydraulic motor 18 and hydraulic pump 17 and of the pressure difference. Although this model generally describes the leakage flow significantly better than the explained simple model, which depends only linearly on the pressure difference, a surprisingly good result of the simple first model 4, which is perfectly comparable with that of the more complex model, is also in fact obtained at changeovers of driving range which are relevant for the invention. In addition, the signal-to-noise ratio of the first model is significantly lower since only one sensor signal is involved in the estimation. A further advantage is the dependence on just one parameter, which makes it possible to use simple robust recursive algorithms for online estimation in the estimation of the leakage flow parameter θ_{Δp}. As a result, the estimated parameter θ_{Δp} can be continuously improved and possible changes in the operating conditions adapted. The online estimation and offline estimation can also be advantageously combined. In this way, the parameter θ_{Δp} can be estimated offline for various operating states such as, for example, the temperature, with the leakage flow θ_{LeakP} then being calculated by means of the parameter θ_{Δp}(T) which is estimated and stored for numerous temperatures.

In order to improve further the estimation of the instantaneous volumetric efficiency level, the measured pressures in the vicinity of the changeover of driving range can be included to a greater extent in the estimation during the offline estimated of the estimated parameter. This can be implemented using a local weighting function which is integrated into the least square algorithm.

In step S12, the pressures are therefore measured with the pressure sensors 33 and 34 of the lines 19a and 19b and transmitted to the estimation device 41 via the control lines 44 and 45. At the same time, the rotational speeds nₚ, n_{M} of the hydraulic motor 18 and of the hydraulic pump 17 are measured with the sensors 65 and 66 and transferred directly to the estimation device 41 via further control lines.

In step S13, as described the overall leakage flow is estimated on the basis of the measured pressure difference and an instantaneous volumetric efficiency level ηᵥ is calculated using the estimated overall leakage flow and the actuation signals and rotational speeds, obtained from the control device 43, of the motor 18 and pump 17, respectively.

In step S14, the volumetric efficiency level ηᵥ is predicted at the start of the second driving range. To do this, the estimation device 41 transfers its result of the intravenous volumetric efficiency level ηᵥ(tₑ_{_{—}}FB1) to the prediction device 42. The prediction device 42 is configured in such a way that it predicts the volumetric efficiency level at the start of the second driving range (tₛ_{_{—}}FB2) with the formula

ηv(tₛ_{_{—}}FB2)=|ηv(tₛ_{_{—}}FB1)−1|·β+ηv(tₛ_{_{—}}FB1) (5)

as a function of the estimated instantaneous volumetric efficiency level ηv(tₑ_{_{—}}FB1) at the end of the first driving range tₑ_{_{—}}FB1. The factor β for setting the jump in the efficiency level is determined experimentally, for example in test bench trials and is defined individually for each changeover of driving range. The direction of the changeover of driving range (FB1->FB2 or FB2->FB1) is therefore also taken into account.

In step S15 it is tested whether, as already described, the synchronization condition has been met, that is to say whether the main output shaft 5 has the same angular speed or rotational speed as the gearwheel 11. If this rotational speed of the gearwheel 11 has not yet been reached, the steps S12 to S14 are carried out continuously since the calculation is not very computationally intensive and the predicted efficiency level is available at any time. The results of the calculation are however only used at the end of the first driving range tₑ_{_{—}}FB1 and are processed when the synchronizing rotational speed is reached. Once this rotational speed has been reached, the clutch 12 is closed in step S16, the corrected transmission ratio is set and the clutch 26 is opened, as has been described above in detail.

In step S17, the control device 43 sets, immediately after the closing of the clutch 12, the actuating angle of the hydraulic motor 18, taking into account the predicted volumetric efficiency level ηᵥ(tₛ_{_{—}}FB2) at the start of the second driving range tₛ_{_{—}}FB2, in such a way that a change in rotational speed at the output of the hydraulic transmission 4, due to the reversal of the power flux in the hydrostatic transmission 4 when the clutch 26 opens, is just compensated. By means of the knowledge of the predicted efficiency level ηᵥ (tₛ_{_{—}}FB2), the ratio required

$$\frac{{α}_{m}}{{α}_{p}} = \frac{η v ( {t}_{s \_ FB 2} ) \cdot {η}_{P} \cdot {V}_{P max}}{{n}_{M} \cdot {V}_{M max}} = a \qquad ( 6 )$$

in order to set the actuation angle of the motor as a function of the actuation angle of the pump can be calculated.

The changeover of driving range from the second driving range as the initial driving range into the first driving range as the target driving range takes place in an analogous fashion. In this context, steps S12 to S14 continue to be carried out continuously in the second driving range, only that in step S14 the volumetric efficiency level ηᵥ(tₑ_{_{—}}FB1) of the end of the first driving range is predicted. The end of the first driving range is the point of the maximum output rotational speed or of the lowest transmission of the first driving range which is characterized by the changeover into the second driving range. Furthermore, as in step S15, it is continuously measured whether the rotational speed has already decreased in the second driving range to such an extent that a synchronization condition is met. If this is not the case, the previously described steps S12, S13 and the analogous step at S14 continue to be carried out.

However, at this changeover of driving range the synchronization condition is no longer defined by means of the same rotational speed of the main driveshaft 5 and gearwheel 11, since these inevitably have the same rotational speed as a result of the closed clutch 12. Instead, in the synchronization condition it is necessary to ensure that during the disconnection of the main driveshaft 5 and the gearwheel 11 as a result of the opening of the clutch 12 the rotational speeds of both components 5 and 11 remain the same. Therefore, when the planet gears 23 are stationary the clutch 26 is closed as a synchronization condition, i.e. when only the planet gears 23 are rotating about their own axis without rotation about the output shaft 6. This guarantees jolt-free closing of the clutch 26. The change in rotational speed caused by the reversal of the power flux in the hydrostatic variator 4 when the clutch 12 opens is just compensated by the setting of the hydraulic motor 18 at the changeover of driving range, taking into account the predicted volumetric efficiency level ηᵥ (tₑ_{_{—}}FB1) at the end of the first driving range. The second power branch can then be disconnected from the main driveshaft 5 by opening the clutch 12 without a dip in the torque. For this purpose, the formula (6) is applied again with the newly predicted efficiency level ηᵥ (tₑ_{_{—}}FB1) instead of ηᵥ (tₛ_{_{—}}FB2). The formula (5) is also used to predict the efficiency level ηᵥ (tₑ_{_{—}}FB1) by interchanging the efficiency levels and a parameter estimated for this changeover of driving range.

A synchronization condition is dependent on the direction of the changeover of driving range. In the case of the mechanical clutch 12, this condition is identical rotational speeds before the connection or identical torques before the disconnection, so that after the disconnection there is no change in rotational speed caused by the disconnection.

FIG. 4 shows measured process variables which confirm a changeover of driving range which is free of interruption in the tractive force and free of jolts. The change in various process variables over time is shown in the two diagrams 58 and 59. The X axis shows the time in seconds, with the transition region between the first and second driving ranges being significant above all. The start of the changeover of driving range or the end of the first driving range is marked by the vertical line 51, while the end of the changeover of driving range or the start of the second driving range is characterized by the vertical line 52.

The first diagram 58 shows a first clutch pressure 53 of the clutch 26 which is closed in the first driving range, for which reason the clutch pressure 53 drops away to zero in the second driving range, i.e. chronologically after the line 52, after the opening of the clutch 26. In an analogous fashion, the clutch pressure 54 of the clutch 12 increases from a negligible clutch pressure 54 in the first driving range to a clutch pressure 54 which corresponds to the closed clutch 12. In the transition region, both clutches 12 and 26 are closed for a short time. The standardized actuation signal 55 of the hydraulic motor 18, which is denoted as u_{M} in the formulas, after the clutch 12 engages in the gearwheel 11, is corrected to the actuation value, calculated from the predicted efficiency level, at the start of the second driving range. Owing to the short overlap time, the high switching dynamic and the adjustment inertia of the hydraulic motor 18, the actuation signal 55 is excessively increased at the beginning. As a result, the deceleration behavior of the adjustment is compensated dynamically and it is ensured that after the short blocking time of the two clutches 12 and 26 the required hydraulic transmission ratio and/or the required pivot angle are/is actually present. When the clutch 26 is disconnected, the first power branch exhibits the required transmission ratio, and there are no undesired changes in torque curve.

The lower diagram 59 shows the tractive force 56 of the main output shaft which does not have any dip in tractive force in the transition region. The second measurement curve 57 shows the absolute difference in pressure between the lines 19a and 19b. The sudden change in direction of the pressure difference 57 at zero directly after the end 52 of the transition region marks the zero crossover of the pressure difference owing to the reversal of the power flux.

The described invention is not restricted to the exemplary embodiment illustrated. Instead, individual features can be advantageously combined with one another.

Alternatively, instead of an internal combustion engine it is, for example, also possible to use an electric motor or some other drive motor, and likewise the hydrostatic variator can be replaced by a mechanical or an electric variator. Basically, the invention can be applied in all power split transmissions with external power splitting.

The invention is particularly advantageous with just two power branches, wherein one has a variator and one has a fixed transmission. However, the invention can also be transferred to transmissions with more than two power branches, wherein at least one power branch has to have a variator and at least one second power branch has to be present. The second power branch does not have to have a fixed transmission here but rather it is also possible to have a plurality of jumps in transmission, a further variator or an electric or hydrodynamic transmission means, however, it is particularly easy and effective to implement the second power branch as a fixed mechanical transmission.

If the second power branch has a plurality of transmission stages, they can also be switched without an interruption in the tractive force. A condition for this are synchronization conditions at the clutches 12 and 26 and also in the case of the further transmissions of the second power transmission.

The control unit 40 can, as described in the exemplary embodiment and shown in FIG. 1, be implemented as a unit 40 which has the estimation device 41, the prediction device 42 and the control device 43, as well as a combination of the devices 41, 42 and 43 by means of cables or else by means of software implementations of the devices 41, 42 and 43 in a control computer with the necessary measuring and control interfaces. The control does not have to be carried out in an electrical fashion, for example by means of electric actuation signals and proportional magnets, but rather can also be implemented hydraulically, for example.

All the weight forces caused by the traction of the earth and all the friction forces which are not explicitly mentioned are ignored in the considerations above.

1. A power split transmission, comprising:
a first power branch with a continuously variable transmission and a second power branch which is disconnectable;
a summing gear mechanism which has a first input, which is connected to the output of the first power branch in a frictionally locking fashion, and a second input which is connected to the output of the second power branch in a frictionally locking fashion;
a device for connecting or disconnecting the second power branch at a changeover from an initial driving range into a target driving range;
a control device configured to control and set the transmission ratio of the continuously variable transmission; and
a prediction device for predicting an efficiency level of the first power branch in the target driving range connected to the control device, which is configured in such a way that the continuously variable transmission is set at a changeover into the target driving range, taking into account the predicted efficiency level, in such a way that a difference in rotational speed due to a change in the power flux in the first power branch at the output of the first power branch is just compensated.

2. The power split transmission as claimed in claim 1, further comprising:
an estimation device for determining an instantaneous efficiency level of the first power branch connected to the prediction device, and a parameter which is estimated online or offline is stored in the estimation device for determining the instantaneous efficiency level.

3. The power split transmission as claimed in claim 1, wherein
the first power branch has a mechanical, electrical or hydrostatic, continuously variable transmission.

4. The power split transmission as claimed in claim 3, wherein
the first power branch has a hydrostatic, continuously variable transmission with a hydraulic pump and a hydraulic motor which are connected to one another via two lines, and the hydraulic pump and/or the hydraulic motor are/is adjustable.

5. The power split transmission as claimed in claim 4, further comprising
a first pressure sensor attached to the first line and a second pressure sensor attached to the second line, and the pressure sensors are connected to an estimation device for determining the instantaneous volumetric efficiency level of the first power branch, which is in turn connected to a prediction device.

6. The power split transmission as claimed in claim 4, wherein
the control device is configured in such a way that during a changeover between the driving ranges the expulsion volume of the hydraulic motor and/or of the hydraulic pump is set, taking into account the predicted efficiency level, in such a way that a difference in rotational speed at the output of the first power branch due to a change in the power flux in the first power branch is just compensated.

7. The power split transmission as claimed in claim 1, wherein
the device for connecting or disconnecting the second power branch is a frictionally locking clutch in the second power branch.

8. A method for changing over from an initial driving range into a target driving range in a power split transmission having a first power branch with a continuously variable transmission and having a second, disconnectable power branch, comprising:
connecting or disconnecting with the second power branch for changing over from the initial driving range into the target driving range when a synchronization condition is met;
predicting the efficiency level of the first power branch in the target driving range before the connecting or disconnecting with the second power branch; and
actuating the continuously variable transmission of the first power branch after the connecting or disconnecting with the second power branch for setting the transmission ratio, taking into account the predicted efficiency level, so that a difference in rotational speed at the output of the first power branch due to a change in the power flux in the first power branch is just compensated.

9. The method as claimed in claim 8, further comprising
determining an instantaneous efficiency level of the first power branch by means of a parameter which is estimated online or offline, and
predicting the efficiency level of the first power branch in the target driving range on the basis of the determined efficiency level.

10. The method as claimed in claim 8, wherein
the power in the first power branch is transmitted mechanically, electrically or hydrostatically and in a continuously variable fashion.

11. The method as claimed in claim 10, wherein
the continuously variable transmission is implemented hydrostatically because in said transmission a hydraulic pump drives a hydraulic motor via two lines, and the hydraulic pump and/or the hydraulic motor are/is adjustable.

12. The method as claimed in claim 11, wherein
the pressure difference between the two lines in the hydrostatic, continuously variable transmission is measured, and the instantaneous volumetric efficiency level of the first power branch is determined on the basis of the pressure difference between the two lines in the hydrostatic, continuously variable transmission, and the volumetric efficiency level of the first power branch in the target range is predicted on the basis of the determined volumetric efficiency level.

13. The method as claimed in claim 11, wherein
at a changeover from the initial driving range into the target driving range the expulsion volume of the hydraulic motor and/or of the hydraulic pump is set, taking into account a predicted volumetric efficiency level, in such a way that a difference in the rotational speed at the output of the first power branch due to a change in the power flux in the first power branch is just compensated.

14. The method as claimed in claim 7, wherein
the second power branch is disconnected and connected by means of a frictionally locking clutch
